(19) United States
(12) Patent Application Publication
(10) Pub. No.: US 2022/0363385 A1
(43) Pub. Date: Nov. 17, 2022

(54) SYSTEM AND METHOD OF VACUUM SHELL AIRFOIL

(71) Applicant: Andrew SHERWIN, South Longboat Key, FL (US)

(72) Inventor: Andrew SHERWIN, South Longboat Key, FL (US)

(21) Appl. No.: 17/735,872

(22) Filed: May 3, 2022

Related U.S. Application Data
(60) Provisional application No. 63/183,571, filed on May 3, 2021.

(51) Int. Cl. B64C 39/06

(52) U.S. Cl. CPC B64C 39/064

(57) ABSTRACT

The invention describes a Vacuum Shell Airfoil which includes: (1) a circular shell, and (2) multiple fins where each of the multiple fins includes a bottom, a top, a front, a back, a first side and a second side wherein at least a portion of the bottom of each of the multiple fins is attached to the circular shell. The Vacuum Shell Airfoil can also include: a stabilization ring positioned above the circular shell where at least a portion of at least two fins are attached to the stabilization ring, a stabilization ring that is positioned above the circular shell where at least a portion of each of the multiple fins is attached to the stabilization ring, multiple fins which are radially positioned along the circular shell, which may further include a cylindrical guard rail positioned around the Vacuum Shell Airfoil. The circular shell of the Vacuum Shell Airfoil may be constructed of carbon fiber and the multiple fins may also be constructed of carbon fibers. The Vacuum Shell Airfoil can be used to more efficiently produce the lift that is necessary to propel and suspend aircraft such as Vertical Take Off and Land (VTOL) aerospace vehicles.

### CROSS REFERENCE TO RELATED APPLICATION

The present application claims the benefit of priority to U.S. Provisional Application No. 63/183,571 filed May 3, 2021, which is hereby incorporated in its entirety including all tables, figures and claims.

### TECHNICAL FIELD

The present disclosure relates to airfoils used to provide lift.

### BACKGROUND OF THE INVENTION

Vertical Take Off and Land (VTOL) aerospace vehicles include jet packs, harrier fighter jets, helicopters, tiltrotors, drones, and numerous flying car attempts. While various embodiments of these vehicles have been available over the years, each of these embodiments have had various shortcomings and each of the models presented can be vastly improved. Most, if not all, of the prior available VTOL vehicles were dangerous and fuel inefficient, making long levitation (or flight) times impossible. For example, human jet packs typically run out of fuel in 90 seconds. Similarly, harrier jets burn approximately 20% of their fuel in 30 seconds during both take-off and landing. In other words, a harrier jet typically burns 20% of its fuel when taking off and an additional 20% of its fuel when landing, leaving only approximately 60% of its fuel to be used for flying and fighting. Helicopters are extremely dangerous and are frequently involved in crashes or accidents. Helicopters are also limited to where they can land and can only fly up to a couple of hundred miles an hour. Moreover, the helicopter blades are extremely dangerous. Drones are showing real progress but, at this time, they lack the strength to carry one, or more, human beings. Real progress has been made in tiltrotors but these vehicles are still quite dangerous and are frequently involved in accidents. What is needed is a different form of propulsion, or a different way to lift objects of large mass vertically in the air. Even more desirable would be vehicles that can take off and land vertically and push through trees and bounce off of buildings without causing damage.

### SUMMARY OF THE INVENTION

The present invention includes a Vacuum Shell Airfoil which includes: (1) a circular shell, and (2) multiple fins where each of the multiple fins includes a bottom, a top, a front, a back, a first side and a second side wherein at least a portion of the bottom of each of the multiple fins is attached to the circular shell. The Vacuum Shell Airfoil can also include: a stabilization ring positioned above the circular shell where at least a portion of at least two fins is attached to the stabilization ring, a stabilization ring that is positioned above the circular shell where at least a portion of each of the multiple fins is attached to the stabilization ring, multiple fins which are radially positioned along the circular shell, which may further include a cylindrical guard rail positioned around the Vacuum Shell Airfoil. The circular shell of the Vacuum Shell Airfoil may be constructed of carbon fiber and the multiple fins may also be constructed of carbon fibers.

The present invention also discloses a method of generating lift, where the method consists of the steps of rotating a Vacuum Shell Airfoil consisting of at least one circular shell and multiple fins attached to the circular shell wherein the rotation of the Vacuum Shell Airfoil is along a vertical centerline of the circular shell. The amount of lift generated by the Vacuum Shell Airfoil may be increased by the addition of a stabilizing ring wherein a portion of the stabilizing ring is attached to the multiple fins. Additionally, the lift generated by the Vacuum Shell Airfoil may be increased by positioning a cylindrical guard rail around the Vacuum Shell Airfoil. In other embodiments, the amount of lift generated by the Vacuum Shell Airfoil may be increased by making at least a portion of the circular shell and/or the multiple fins of carbon fiber.

The present invention also discloses a method of generating lift on an aircraft where the method includes the steps of attaching multiple Vacuum Shell Airfoils to an outside surface of the aircraft where each of the multiple Vacuum Shell Airfoils includes a circular shell and multiple fins attached to the circular shell, and rotating more than one of the Vacuum Shell Airfoils such that the total lift generated by the Vacuum Shell Airfoils that are generating lift is sufficient to propel the aircraft. This method of generating lift on an aircraft may include a stabilizing ring wherein a portion of the stabilizing ring is attached to at least two of the multiple fins of the at least one of the Vacuum Shell Airfoils. In one or more embodiment, the amount of lift generated by the Vacuum Shell Airfoil may be increased by positioning a cylindrical guard rail around the Vacuum Shell Airfoil, or by making at least a portion of the circular shell, and/or the multiple fins of carbon fiber.

### BRIEF DESCRIPTION OF THE DRAWINGS

The drawings are meant to illustrate the principles of the invention and do not limit the scope of the invention. While some of the drawings includes sample dimensions, the invention is not limited to embodiments having the sample dimensions shown. The above-mentioned features and objects of the present disclosure will become more apparent with reference to the following description taken in conjunction with the accompanying drawings wherein like reference numerals denote like elements in which:

FIG. 1 shows a partial cross section of a Vacuum Shell Airfoil;

FIG. 2 shows a top view of a Vacuum Shell Airfoil;

FIG. 3A shows a cross section of the predicted manner in which air will flow over the top of the Vacuum Shell Airfoil under traditional Bernoulli's principles;

FIG. 3B shows the air flow over the top of a traditional air foil under traditional Bernoulli's principles;

FIG. 4 shows the exit area is much greater than the entrance area causing shedding/decompression because the air is being vented off faster than it can be replaced;

FIG. 5 shows that when the Vacuum Shell Airfoil is spinning at high speeds the air molecules are “flung” off of the surface of the Vacuum Shell Airfoil;

FIG. 6 shows one embodiment of how multiple Vacuum Shell Airfoils may be positioned on a helicopter to replace the main rotor and the tail rotor of the helicopter;

FIG. 7 shows a top view of the possible positioning of multiple Vacuum Shell Airfoils on top of a helicopter body;

FIG. 8 shows the shell without fins of the Vacuum Shell Airfoil with sample dimensions;

FIG. 9 shows a cross section of the shell of the Vacuum Shell Airfoil with sample dimensions;

FIG. 10 shows one manner in which slits can be used to add fins to the Vacuum Shell Airfoil with sample dimensions;

FIG. 11 shows a cross section of the shell and where slits may be cut to position the fins with sample dimensions;

FIG. 12 shows sample dimensions of one possible fin size;

FIG. 13 shows a possible final assembly of the fins with the shell with sample dimensions;

FIG. 14 shows the air current in the absence of a stabilization ring;

FIG. 15 shows the air current in the presence of a stabilization ring;

FIG. 16 shows a stabilization disc which may be used as a replacement for stabilization ring;

FIG. 17 is a top view of a Vacuum Shell Airfoil with a stabilization disc;

FIG. 18 shows a cross section of a VSA with a stabilization ring;

FIG. 19 is a top view of a one example of a Vacuum Shell Airfoil;

FIG. 20 is an angled view of a Vacuum Shell Airfoil;

FIG. 21 is an enlarged cutaway view of a Vacuum Shell Airfoil.

### DETAILED DESCRIPTION OF THE INVENTION

After 20 years and 16 airfoil attempts, a new form of propulsion has been invented that will give mankind the ability to vertically take off, levitate or fly for long periods of time, and safely and successfully descend vertically and land. It is called a Vacuum Shell Airfoil (VSA). The present invention discloses a way to vertically take off, levitate, fly for long periods of time, and safely and successfully descend vertically and land while using very low amounts of fuel or energy. This will result in increased flight and levitation times.

Over the last 20 years, I have encountered many fundamental misunderstandings of flight, and how flying machines and wings and air pressure work. The key to how every propeller, helicopter rotor, and airplane wing works is widely misunderstood. Propellers, helicopter rotors, and airplane wings are all airfoils. One of the biggest misunderstandings of airfoils is that people think that airfoils work by driving or pushing air downwards. Airfoils work because of a change in the way gaseous atoms (and liquid) “dance” on the top surface area of the airfoil or wing. This change in the way atoms “dance” subsequently results in a “lowering” of the air pressure on the top surface. Airplane wings do not “compress” air underneath the wing, instead wings produce lift because of a “decompression” of the air pressure on the top surface area. The “change” in pressure is caused by a change in the way the atoms “dance” or interact with a surface area. This “change” is usually caused by air moving rapidly over a descending curve, which changes the way that atoms are exchanging momentum at the molecular level of the surface area, which subsequently leads to a change in pressure. Pressure is caused, for example, by billions of molecular collisions pounding on a 1 square inch surface area over a period of 1 second. At sea level, the pressure is 14.7 pounds per square inch (14.7 lbs/in²). If the way that atoms “dance” could be mastered, we could cause large “changes” in pressure on small surface areas, inside of guard rails, lifting large masses, pushing through trees, bouncing off buildings and safely landing anywhere. This has been the goal of my 20 years of hobby and research. This patent application encompasses my findings over the last 20 years.

### Vacuum Shell Airfoil (VSA)

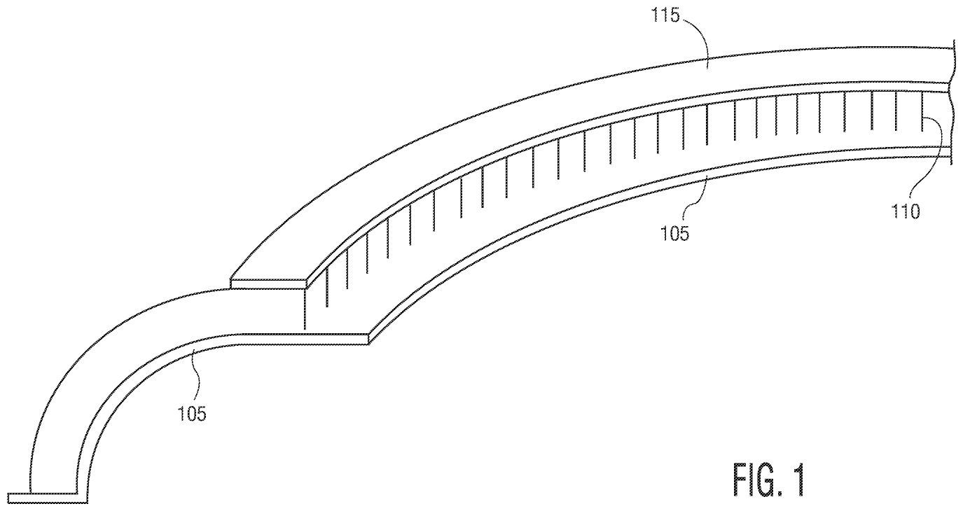

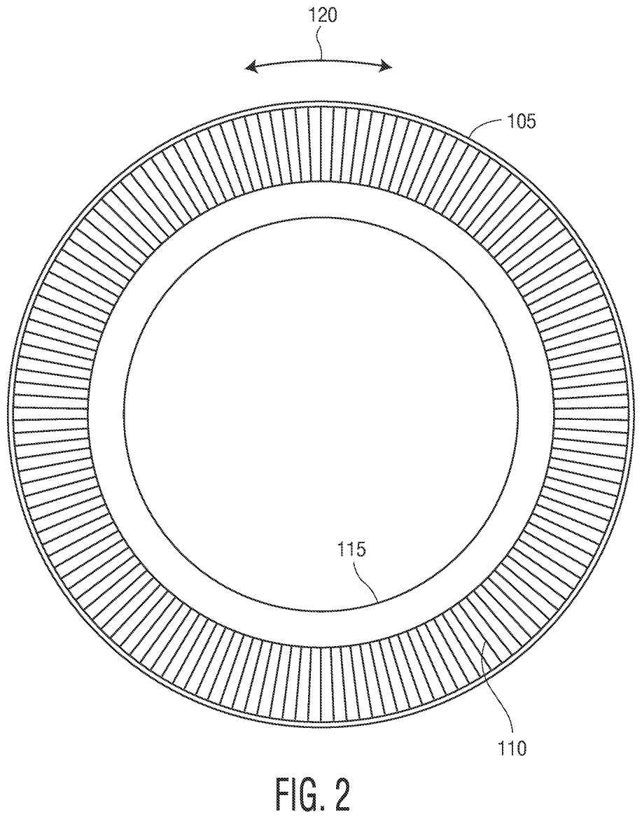

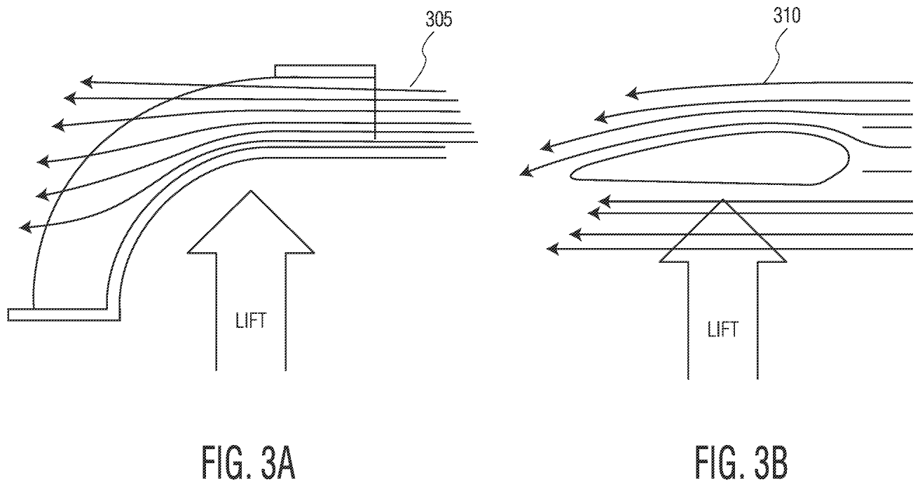

FIGS. 1 and 2 show a representative Vacuum Shell Airfoil (“VSA”) (or a portion thereof) which preferably includes 3 major components: (1) a circular “shell” 105 with a descending curve of the outer top edge, (2) a dense conglomeration of short, almost parallel “fins” 110 on the top side of the “shell”, and (3) a “stabilization ring” 115. While the stabilization ring 115 is not a requirement, the presence of the stabilization ring 115 is desirable because it greatly increases airfoil efficiency and the reduction of turbulence. When the VSA is spinning along its plane (in either direction of arrow 120), the air between the short blades (or fins) 110 experiences centrifugal forces that makes the air flow 305 (FIG. 3A) move rapidly over the descending curve and outwardly off the VSA (FIG. 3A), similar to the flow of air 310 over an airplane wing. (FIG. 3B). One of ordinary skill in the art would understand how to rotate the VSA which is similar to how the rotor blades of a helicopter are rotated. FIG. 3A shows the left side VSA cross section and air currents under traditional Bernoulli's Principles. FIG. 3B shows the airflow over a traditional airplane wind under traditional Bernoulli's Principles. In both FIGS. 3A and 3B lift is in the upward direction.

1. Shell (105): is the circular curved base of the VSA (which can range in diameter from very large to very small). The model built and tested has a diameter of 40 inches.

2. Fins (110): A dense conglomeration of short, almost parallel fins covering the top of the descending curve of the Shell 105. The model built and tested has 440 fins that were 0.5 inches tall and placed slightly less than 0.25 inches apart. Other configurations and numbers of fins are included in the present invention.

3. Stabilization Ring (115): A preferably flat ring covering, placed on top of, at least a portion of the Fins 110 on the flat part of the Shell 105 preferably at the beginning of the descending curve as shown in FIGS. 1 and 2. FIG. 1 shows a partial cross section of the VSA.

### Description of Lift Forces on the VSA

The Vacuum Shell Airfoil (VSA) was invented and designed to produce large pressure changes on small surface areas contained inside protective circular guard rails so that we can build Vertical Take Off and Land vehicles (VTOL) that can bounce off buildings/structures and push through trees/brush (without damage) and safely land anywhere (including on water). As the VSA spins faster and faster, forces of lift grow exponentially due to 3 different physical reasons.

At slower speeds, the first force of lift experienced by the VSA is due to traditional Bernoulli's Principle of air moving faster over the top of the descending curve than the speed of the air underneath, resulting in a reduction of pressure on the top of the VSA, just like a traditional airplane wing (See FIGS. 3A and 3B).

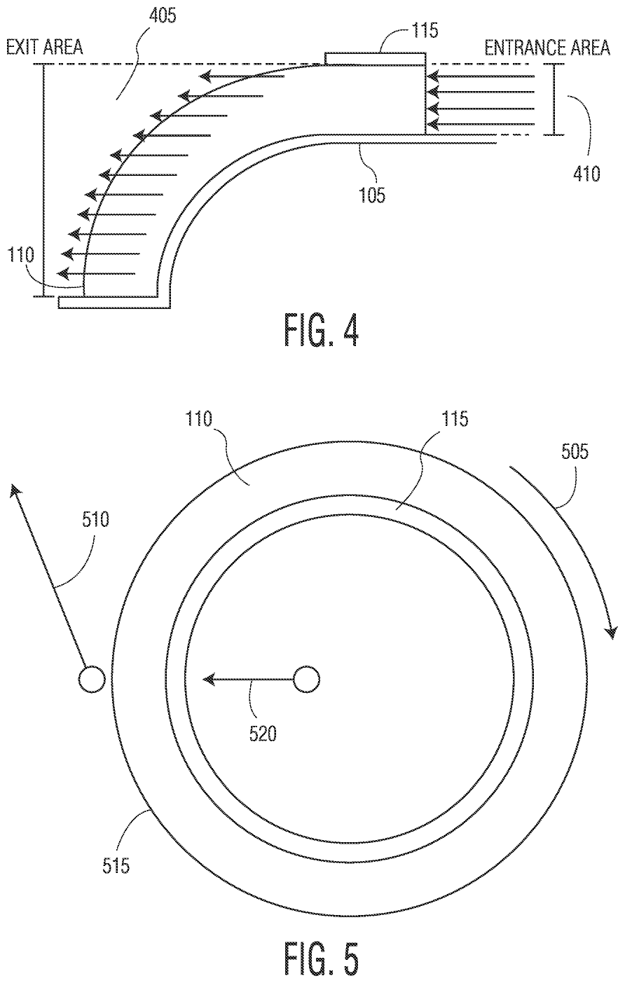

The second distinct force of lift experienced by the VSA comes from what is referred to herein as “Shedding/Decompression”. Shedding/Decompression occurs where and when the VSA begins to spin at a speed so fast that the air being “shed” off the VSA is being ‘shed” so fast that it cannot be replaced by the incoming air. FIG. 4 shows the exit area 405 is much greater than the entrance area 410 which causes shedding/decompression because the air is being vented off faster than it can be replaced. When this happens, a “Decompression zone” forms on the top of the VSA, resulting in large pressure changes and large amounts of lifting force (FIG. 4). It is believed that this happens because the air in between the fins is being shed faster than it can be replaced. If more air is being shed then can be replaced, a “decompression” of the air in the zone directly affecting the top surface will occur (FIG. 4).

As the VSA crosses over to speeds that are faster than the speed of sound (344 meters per second on a standard day at sea level), it will experience the 3rd and most powerful force of lift, which is called herein “Vectoring” (FIG. 5). “Vectoring” is when the speed of the airfoil is beginning to reach speeds of the gas molecules, which adds so much kinetic energy to the already high speeds of the molecules, that the molecules have so much kinetic energy in their new “vector” that the molecules are “ripped” or “fly” off the top surface of the VSA. This results in the formation of a “vacuum shell” on the top of the VSA. Hence the name “Vacuum Shell Airfoil”.

FIG. 4 illustrates Shedding/Decompression. In FIG. 4, one of ordinary skill in the art would appreciate that the exit area 405 of the air being shed is many times greater than the area of the entrance 410 by which the air comes into the area between the fins on the descending curve, before centrifugal forces “shed” or expel the air through a much larger area. When the speed of the air coming in needs to be more than the speed of sound to replace the large amounts of air being “shed”, a “decompression” zone forms resulting in large forces of lift.

FIG. 5 shows that when the Vacuum Shell Airfoil is spinning at high speeds the air molecules are “flung” off of the surface of the Vacuum Shell Airfoil. This illustrates what is termed herein as Vectoring. Air molecules in air at room temperature already have average speeds of 500 meters per second 520. When the VSA is spinning at super speeds in direction 505 at, for example 400 meters/second, kinetic energy is added to the molecules vector, that the molecules “rip” or “fly off” 510 at, for example, 900 meters/second off of the VSA top surface 515, resulting in the formation of a vacuum shell and huge lifting forces.

### Description of Fin Arrangements, Fin Heights, and Distance Between Fins

The Vacuum Shell Airfoil is a circular “shell” 105 with an outwardly descending curve (FIG. 1), covered with a dense conglomeration of numerous almost parallel short “fins” 110 on the top surface 110 (FIGS. 1 and 2). Preferably, the height of the “fins” should exceed the distance between the “fins”. The mathematical ratio of “fin height” vs. “distance between fins” is defined as Fin Density. The “fin density” is extremely important to the functioning and stability of the Vacuum Shell Airfoil. Simply put, the greater the number of “fins”, the greater the stability, all the way to the point where the number of “fins” is taking up too much of the “shell's” top surface area. The “fins” also have a certain thickness. The “fin density” is most important to the functioning of the VSA because it is the “fins” and the air between the height and the distance between the “fins”, that are going to effectuate the rapid movement of air over the descending top surface area of the “shell”. It is believed that this happens because the air between the “fins” is being accelerated by the speed of the rotating VSA (shell, fins, and stabilization ring—when present). This acceleration of the air between the “fins” causes a large centrifugal force on the air between the fins, which is what makes the air “fly off” or “shed” off of the VSA. The air rapidly “shedding” off the top surface of the “shell”, is what causes the rapid flow of air over the descending curvature of the “shell”, which subsequently leads to the 3 different forces of lift described with respect to FIGS. 3, 4, and 5.

Without the “fins”, and only a “bare” top surface area of the “shell”, the air directly interacting with the top surface would not be accelerated or made to move rapidly in a controlled and streamlined way over the descending curve of the “shell”. Hence having a large number of short, almost parallel fins drastically affects the speed, direction, currents and molecular interaction of the air on the top surface area of the “shell” or VSA.

Fin Height: Since we are only trying to affect the pressure on the top surface area of the “shell” at the atomic level, the “height” of the “fins” does not need to be very tall. In fact, the taller the “fins”, the more air is being accelerated. Accelerating more air means more mass is being “shed” off the VSA, meaning a less efficient airfoil. Preferably, large masses of air do not need to be accelerated. Only the air at the molecular level of the top surface of the shell needs to be affected. Hence a preferable configuration is a large number of almost parallel “short fins” with a “fin density ratio” greater than 1.00. The height of the “fins” is dependent upon the size of the VSA being built. For large VSA (1-2 meter diameter), probably no more than 1-2 inches tall (2.5 cm-5 cm) (for example) and only separated by, for example, 0.50 inches. While the fins are described as “parallel,” one of ordinary skill in the art would understand that the fins are not truly “parallel” because the distance between adjacent fins at the inside circumference of the shell is smaller than the distance between adjacent finds at the outside circumference of the shell.

For the experiment shown in the included figures, the “fin density” is roughly 2.5. Where the VSA is 40 inches in diameter and has 440 “fins” that are 0.50 inches tall and are 0.20 inches apart.

$$Fin Density = \frac{Fin Height ( 0.5 )}{Distance between fins ( 0.2 )} = 2.5$$

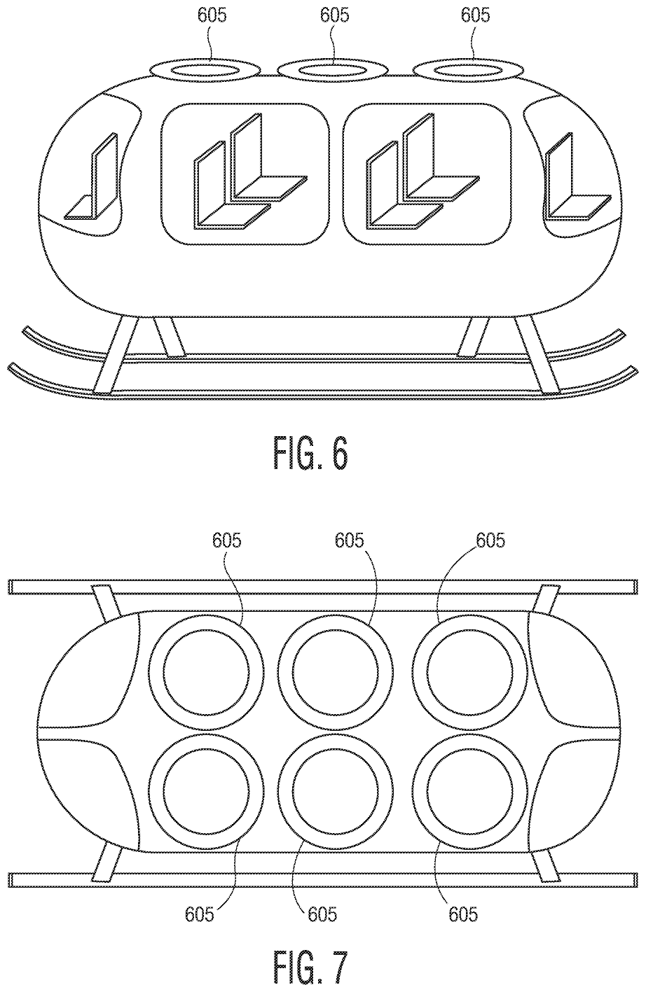

FIG. 6 shows one embodiment of how multiple Vacuum Shell Airfoils 605 may be positioned on a helicopter to replace the main rotor and the tail rotor of the helicopter. FIG. 7 shows another view of the positioning of multiple Vacuum Shell Airfoils 605 on a helicopter. The helicopter illustrated in FIG. 7 is expected to be able to carry heavy loads or people and/or equipment. Preferably, each of the Vacuum Shell Airfoils 605 pictured in FIGS. 6 and 7 would be powered by independent motors.

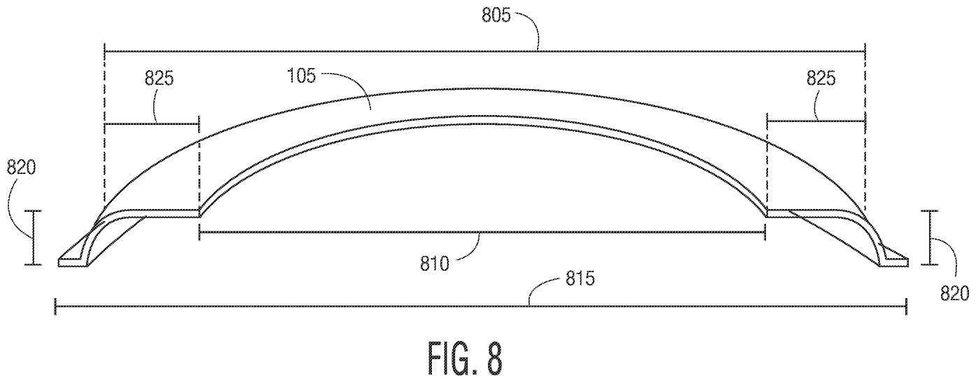

FIGS. 8-13 provide preferrable measurements of one embodiment of a Vacuum Shell Airfoil. One of ordinary skill in the art would appreciate that the invention is not limited to embodiments encompassing the preferrable measurements illustrated in FIGS. 8-13 and that Vacuum Shell Airfoils with other dimensions are included with the scope of the invention. FIG. 8 shows the shell without fins of the Vacuum Shell Airfoil. In one embodiment and as shown in FIG. 8, the width 805 from the beginning of the curve on one side to the beginning of the curve on the opposite side is, for example, 32 inches. In this embodiment, the width of the inside diameter 810 is 28 inches, for example, and the width of the outside diameter 815 is, for example, 40 inches. The height 820 is approximately 3 inches, for example, and the width of the flat area 825 is, for example, 2 inches.

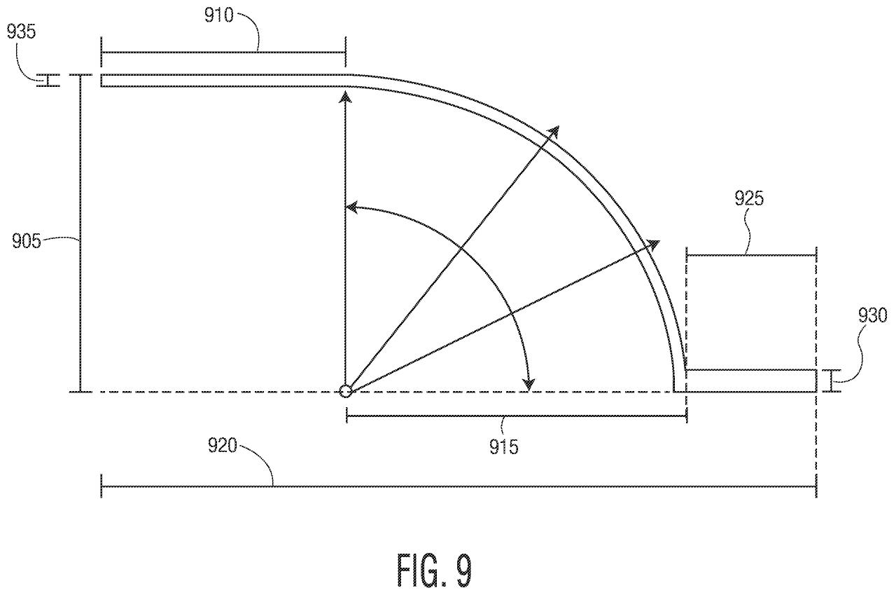

FIG. 9 shows a cross section of the shell of the Vacuum Shell Airfoil. As shown in FIG. 9, in one embodiment, the height 905 is 3 inches; the flat portion 910 is 2 inches, the radius 915 is 3 inches, the width 920 is 6 inches, the lip 925 is 1 inch, thickness 930 is ¼ inch and thickness 935 is ⅛ inch. In this embodiment, the inside diameter is 28 inches and the outside diameter is 40 inches. Each of these dimensions are example dimensions and the invention disclosed and claimed is not limited to these dimensions.

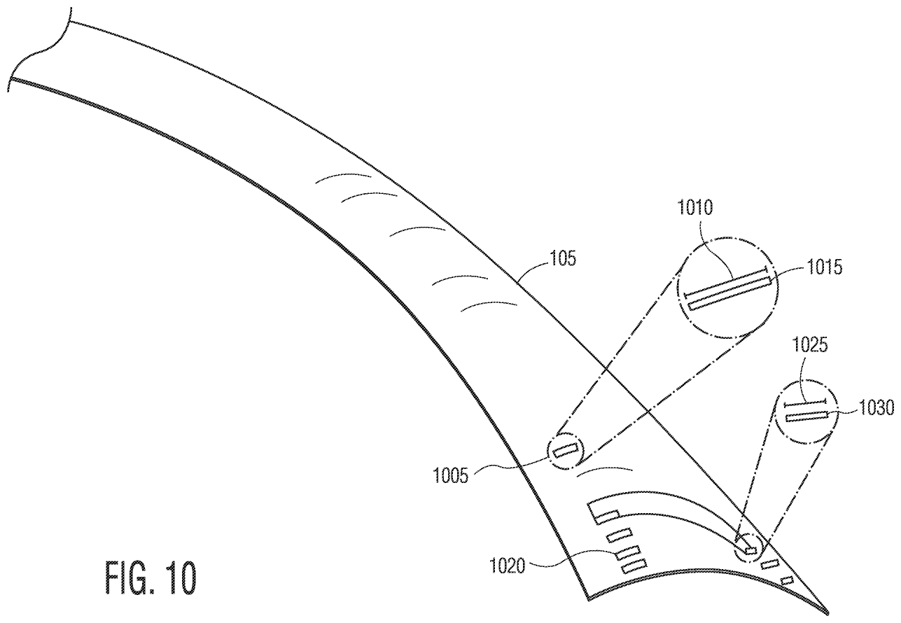

FIG. 10 shows one manner in which slits can be used to add fins to the Vacuum Shell Airfoil. In this embodiment, slits 1005 are cut into the shell 105 with a width 1010 of ½ an inch and a height 1015 of 1/20 of an inch and slits 1020 are cut into shell 105 with a width 1025 of ¼ inch and a height 1030 of 1/20 of an inch. In one embodiment, 440 slits 1005 and 440 slits 1020 were cut into shell 105 for the insertion of 440 fins (not shown). Each of these dimensions are example dimensions and the invention disclosed and claimed is not limited to these dimensions.

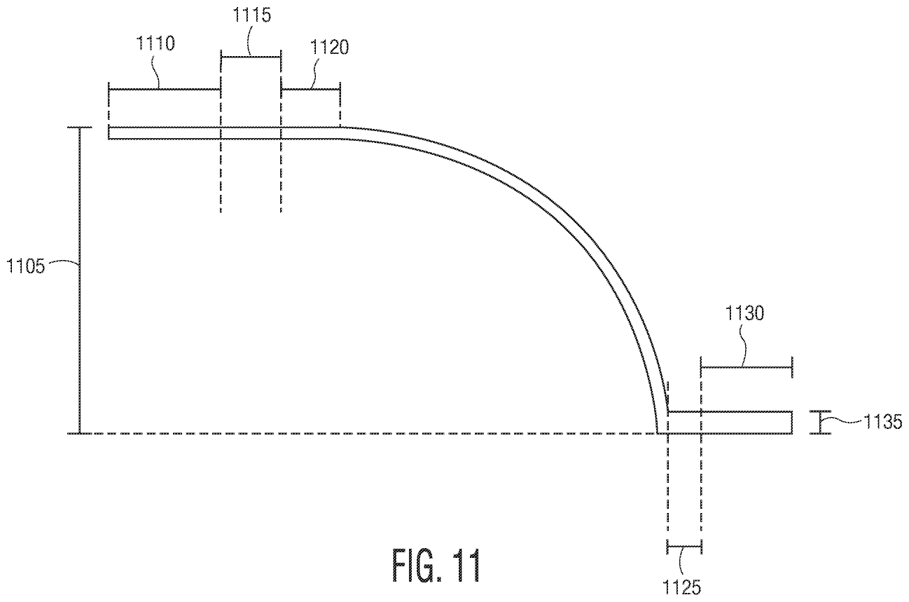

FIG. 11 shows a cross section of the shell and where slits may be cut to position the fins. In this embodiment, the height 1105 is 3 inches and the slits are cut a distance of 1110 of 1 inch from the end, with a width 1115 of ½ inch and distance 1120 of 0.5 inches from the beginning of the curve. Slit two of a width 1125 of ¼ inch is positioned 1130 of ¾ inch in a portion of the material that is 1135 or ¼ inch thick. Each of these dimensions are example dimensions and the invention disclosed and claimed is not limited to these dimensions.

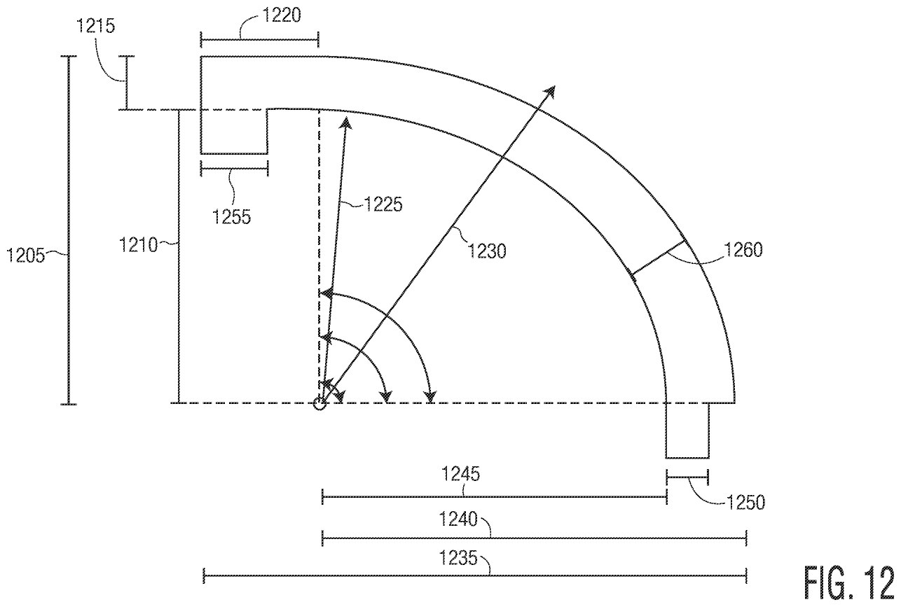

FIG. 12 shows possible dimensions of one possible fin size. In this embodiment, the height 1205 is 3.5 inches, height 1210 is 3 inches, height 1215 is 0.5 inches, width 1220 is 1 inch, width 1225 is 0.5 inches, radius 1225 is 3 inches, radius 1230 is 3.5 inches, width 1235 is 4.5 inches, width 1240 is 3.5 inches, width 1245 is 3 inches, width 1250 is ¼ inch and thickness 1260 is 0.5 inches. One preferred material for the fins 110 is 1/20 inch aluminum. Each of these dimensions are example dimensions and the invention disclosed and claimed is not limited to these dimensions.

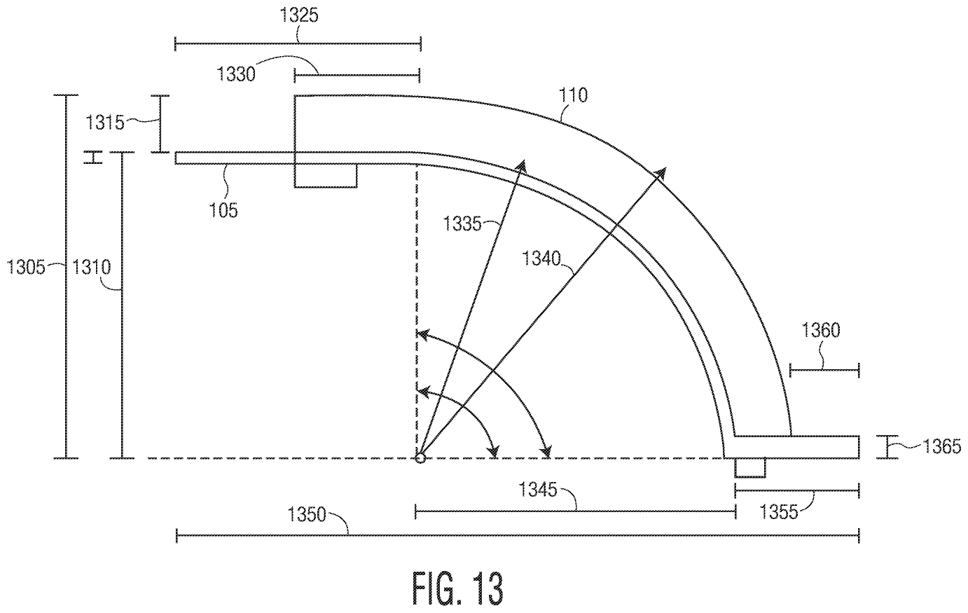

FIG. 13 shows a possible final assembly of the fins with the shell. In this embodiment, the height 1305 is 3.5 inches, height 1310 is 3 inches, height 1315 is ¼ inch, height 1320 is 0.5 inches, width 1325 is 2 inches, width 1330 is 1 inch, radius 1335 is 3 inches, radius 1340 is 3.5 inches, width 1345 is 3 inches, width 1350 is 6 inches, width 1355 is 1 inch, width 1360 is 0.5 inches and thickness 1365 is ¼ inches. Each of these dimensions are example dimensions and the invention disclosed and claimed is not limited to these dimensions.

Again, one of ordinary skill in the art would appreciate that the foregoing measurements are include as example measurements and the invention is not limited to these measurements.

Fin Height Diagram Description (FIGS. 12 and 13)

The “fin height” is the distance from the top of the fin to the shell. Preferably, the height of the fin is consistent throughout the downslope of the shell. Meaning that in FIG. 12, where the fin height is 0.50 inches, the fin is preferably 0.50 inches tall from the flat top of the shell all the way to the bottom of the descending curve as shown in the final assembly of shell and fins in FIG. 13. Please note that the diagrams are the specifications and dimensions of the built VSA in pictures and the invention is not limited to these specifications or dimensions. Future VSAs may be bigger with taller fins or smaller VSAs with even shorter fins. Also note that the diagrams are specific for the originally built experiment in the figures and the invention is not limited to this configuration. In this embodiment, the curvature of the shell is one quarter turn of a circle with a 3 inch radius. Future VSAs will also have different curvatures depending on their size. Large diameter VSAs have larger circumferences, which spin at much greater speed may only require shallower curves.

Depending on the size and speed that VSA are intended to be, will ultimately decide the curvatures of the shells and the size, height and shape of the fins. Regardless of these variables, all VSA shapes, designs, dimensions and speeds still work on the same principle of covering the top of a circular, outwardly descending curve “shell” with a dense conglomeration of short fins so as to effectuate a rapid movement of air currents on the top of the “shell”, resulting in pressure changes and causing forces of lift on the vacuum shell airfoil.

Materials

Preferably, the materials that will be used to make Vacuum Shell Airfoils may be metals, plastics, composites, ceramics, and/or carbon fibers. Each material type has its benefits and downfalls. Metals are very strong and come in many different forms and alloys, yet are usually heavy and expensive. Titanium alloys and ceramics are some of the strongest materials known, yet titanium is extremely expensive. Plastics and plastic VSA are cheap and easy to mass produce, but plastics do not hold up well at high temperatures and may deform at those temperatures, especially undergoing extreme centrifugal force when spinning the VSA. When VSA and objects spin at speeds greater than the speed of sound, they become very hot because of the increased kinetic energy of the molecules in the VSA. It is believed that most VSAs in the future will be made out of aerospace grade aluminum, steel and nickel alloys and/or a wide range of composites like fiberglass which are very light and strong. However, the invention is not limited to these composites. In the end, it is believed that the best material to make the VSA, are carbon fibers. Again, the invention is not limited to VSAs manufactured from carbon fibers. Carbon fibers are very light, stronger than steel and can resist very high temperatures. The only downfall is that making things out of carbon fibers is very expensive and complex from a manufacturing perspective because the carbon fibers have to be woven and laid in glued layers. In conclusion the VSA can be made from a wide range of materials depending on the mass production requirements of the VSA. It could be plastics for toys and titanium and carbon fibers for military vehicles. The model VSA built was made out of an aerospace grade aluminum, where the “shell” was carved out of a $4,000 block of aluminum.

Stabilization Ring/Disk

The purpose of the stabilization ring/disk 115 is to stabilize and streamline the air entering into the beginning of the fins. (FIGS. 3 and 4) The stabilization ring/disk 115 also protects the streamlined flow of air currents through the fins from turbulence spilling over the guard rails when in flight. The purpose of the VSA is to efficiently produce large amounts of lift so as to open the door to a new class of vertical take-off and land vehicles (VTOL). Once levitated by the VSA, the VSA has to continue to provide lift while in horizontal flight from one place and to another. Hence the VSA will probably always be inside of cylindrical guard rails that protect the functioning surface of the VSA from cross winds, turbulence, branches, debris, bullets, and other things to bump into.

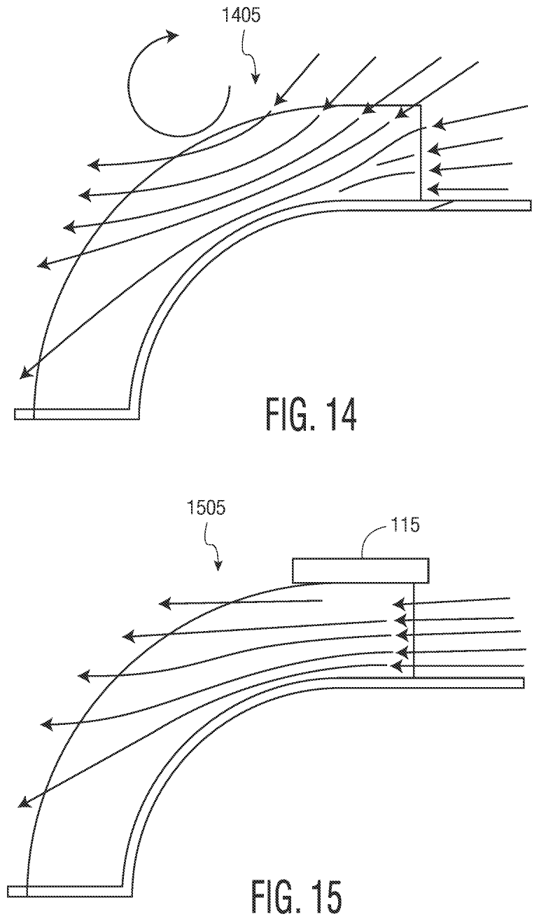

Without the stabilization ring/disk 115, it is probable that too much air coming from multiple angles 1405 (FIG. 14) may ruin the streamlining and efficiency of the airfoil. When the stabilization ring 115 is present, it is believed that all of the air 1505 coming into the fins is all coming from approximately the same angle. (FIG. 15) This greatly reduces the amount of air that needs to be accelerated and subsequently it is believed that it makes the VSA much more efficient. On top of that, since less air is making it into the fins and down the descending curve, the speed of the air rapidly increases to handle the much larger exit area of the VSA (FIG. 4). In general, the faster the air, the greater the force of lift.

As for the dimensions of the stabilization rings/disk, this also varies with the size of the VSA being designed. For the model VSA built, the stabilization ring has an outer diameter of 32 inches and an inner diameter of 30 inches. The stabilization ring rests on and above the first one inch of fins in the flat top surface area, ending right at the beginning of the descending curve. (FIG. 4)

Stabilization Disk

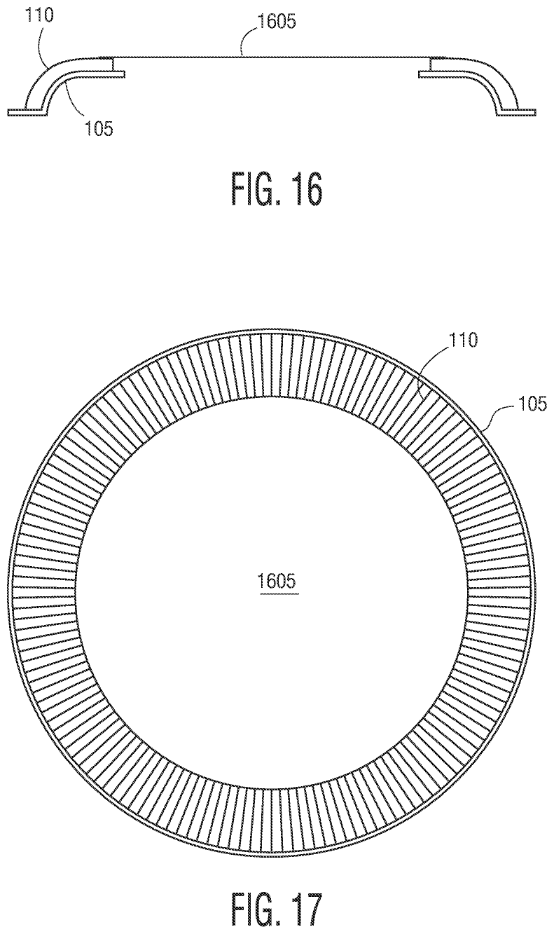

Instead of just having a stabilization ring that covers the fins 110 (or a portion of the fins), some embodiments may cover the entire top of the VSA with a stabilization disk 1605 (FIG. 16). This might offer further protection from branches, debris, cross currents, turbulence and last but not least, rain and water.

FIG. 17 is a top view of a Vacuum Shell Airfoil showing the shell 105, the fins 110 and the stabilization disc 1605.

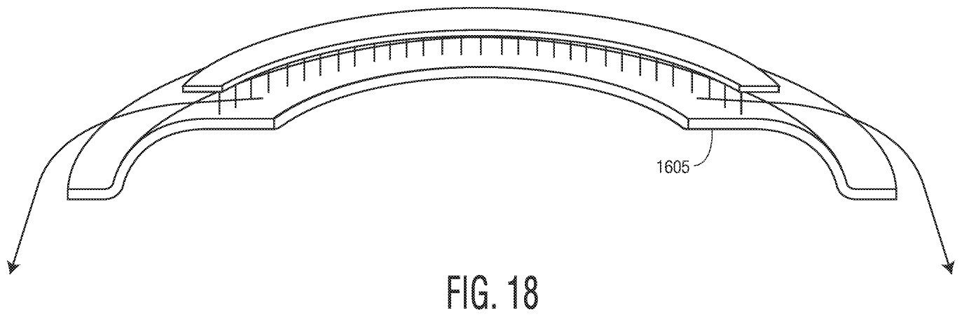

FIG. 18 shows a cross section of a VSA with a stabilization ring 1605 or a guard rail.

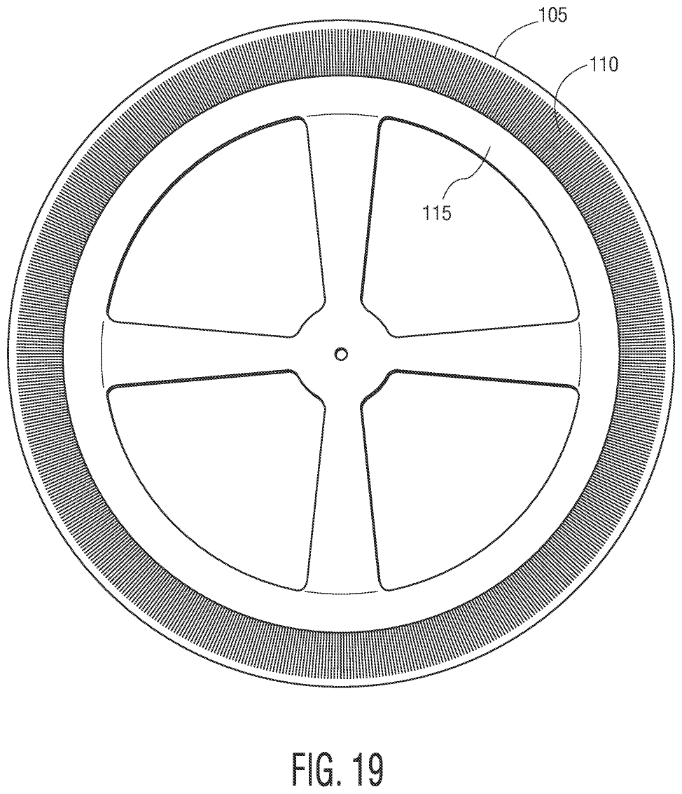

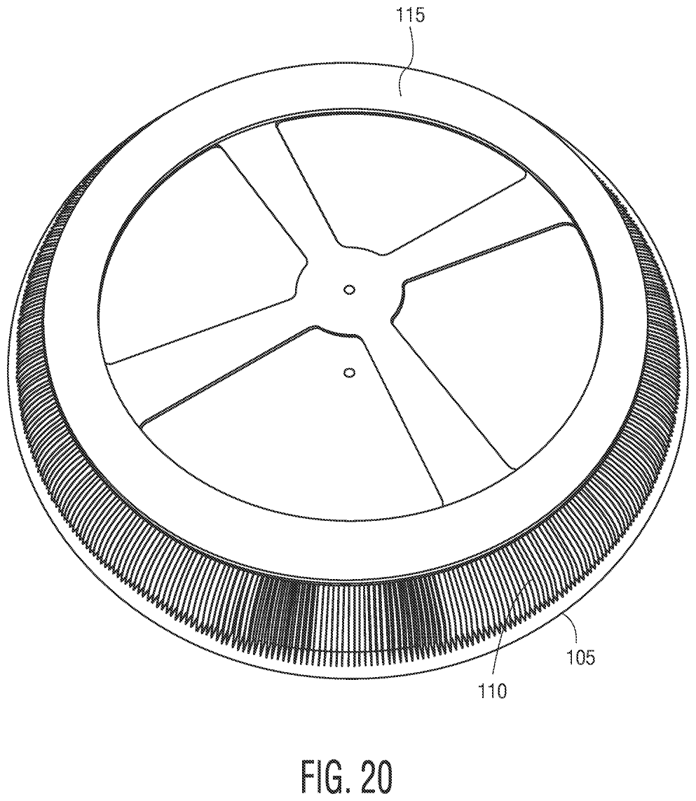

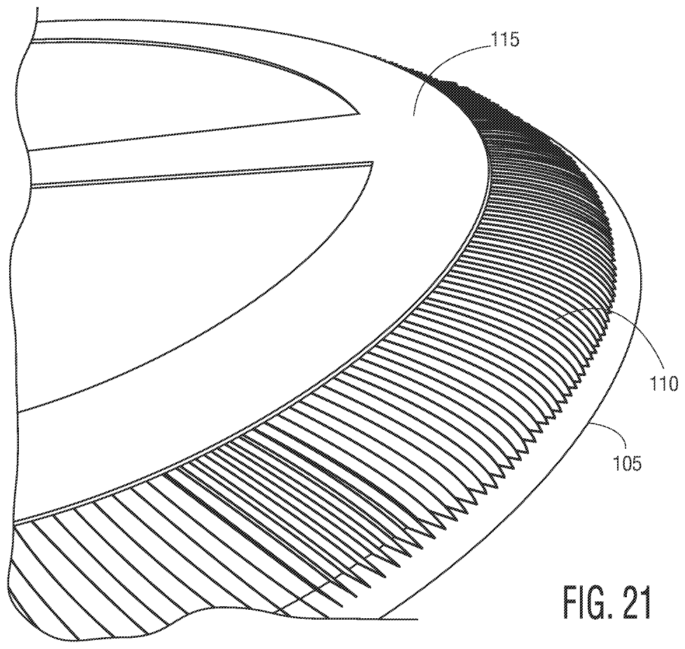

FIG. 19 is a top view of a one example of a Vacuum Shell Airfoil. FIG. 20 is an angled view of a Vacuum Shell Airfoil, and FIG. 21 is an enlarged cutaway view of a Vacuum Shell Airfoil. Each of these figures shows the shell 105, the fins 110, and the stabilizing ring 115.

Guard Rails and Other Accessories

As mentioned previously, the VSA or most VSAs will be spinning inside of circular of cylindrical guard rails. The guard rails, just like the VSA, can be made by many different materials in many different styles. Of course, most if not all guard rails should be wider than the VSA that it is protecting and wide enough that the VSA can “breathe”. Meaning the width of the guard rail will normally be great enough so that air can vent off of the VSA and escape out of the guard rail without interfering with the currents and functioning of the VSA. Preferably, the guard rails will be slightly conical to aid in a downward venting of the air.

Attachment of VSA to a Central Axle

The VSA can be attached to a central spinning axle in numerous ways. The VSA can be attached with arms or spokes, mounted on disks and or wheels, and whatever way that wheels, rotors, and propellers are attached to their axles. The way that a VSA is attached to an axle depends on its size and the materials that the “shell” is made out of. Obviously whatever attachment used should be strong enough to withstand the anticipated lifting force which may be in the thousands of pounds.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure

It must be noted that as used herein and in the appended claims, the singular forms “a”, “and”, and “the” include plural references unless the context clearly dictates otherwise.

While the present disclosure has been described with reference to the specific embodiments thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

1. A Vacuum Shell Airfoil including:
a circular shell, and
multiple fins where each of said multiple fins includes a bottom, a top, a front, a back and a first side and a second side wherein at least a portion of the bottom of each of said multiple fins is attached to said circular shell.

2. The Vacuum Shell Airfoil of claim 1 further including:
a stabilization ring positioned above said circular shell where at least a portion of at least two fins is attached to said stabilization ring.

3. The Vacuum Shell Airfoil of claim 1 further including:
a stabilization ring positioned above said circular shell where at least a portion of each of said multiple fins is attached to said stabilization ring.

4. The Vacuum Shell Airfoil of claim 3 wherein said multiple fins are radially positioned along said circular shell.

5. The Vacuum Shell Airfoil of claim 4 further including a cylindrical guard rail positioned around said Vacuum Shell Airfoil.

6. The Vacuum Shell Airfoil of claim 5 wherein the material of said circular shell is carbon fiber.

7. The Vacuum Shell Airfoil of claim 6 wherein the material of said multiple fins is carbon fibers.

8. A method of generating lift, said method consisting of the steps of:
rotating a Vacuum Shell Airfoil consisting of at least one circular shell and multiple fins attached to said circular shell wherein the rotation of said Vacuum Shell Airfoil is along a vertical centerline of said circular shell.

9. The method of generating lift of claim 8 wherein the amount of lift generated by said Vacuum Shell Airfoil is increased by adding a stabilizing ring wherein a portion of said stabilizing ring is attached to said multiple fins.

10. The method of generating lift of claim 9 wherein the amount of lift generated by said Vacuum Shell Airfoil is increased by positioning a cylindrical guard rail around said Vacuum Shell Airfoil.

11. The method of generating lift of claim 10, wherein the amount of lift generated by said Vacuum Shell Airfoil is increased by making at least a portion of said circular shell of carbon fiber.

12. The method of generating lift of claim 11, wherein the amount of lift generated by said Vacuum Shell Airfoil is increased by making at least a portion of said multiple fins of carbon fibers.

13. A method of generating lift on an aircraft said method comprising the steps of:
attaching multiple Vacuum Shell Airfoils to an outside surface of said aircraft,
each of said multiple Vacuum Shell Airfoils includes a circular shell and multiple fins attached to said circular shell, and
rotating more than one of said Vacuum Shell Airfoils such that the total lift generated by the Vacuum Shell Airfoils that are generating lift is sufficient to propel said aircraft.

14. The method of generating lift on an aircraft of claim 13 wherein at least one of said Vacuum Shell Airfoils includes a stabilizing ring wherein a portion of said stabilizing ring is attached to at least two of said multiple fins of said at least one of said Vacuum Shell Airfoils.

15. The method of generating lift on an aircraft of claim 14 wherein the amount of lift generated by said Vacuum Shell Airfoil is increased by positioning a cylindrical guard rail around said Vacuum Shell Airfoil.

16. The method of generating lift on an aircraft of claim 15, wherein the amount of lift generated by said Vacuum Shell Airfoil is increased by making at least a portion of said circular shell of carbon fiber.

17. The method of generating lift on an aircraft of claim 16, wherein the amount of lift generated by said Vacuum Shell Airfoil is increased by making at least a portion of said multiple fins of carbon fibers.
